(19) United States
(12) Patent Application Publication
(10) Pub. No.: US 2008/0276029 A1
(43) Pub. Date: Nov. 6, 2008

(54) Method and System for Fast Flow Control

(76) Inventor: Ryan S. Haraden, Rochester, MN (US)

Correspondence Address: CANTOR COLBURN LLP - IBM ROCHESTER DIVISION, 20 Church Street, 22nd Floor, Hartford, CT, 06103, US

(21) Appl. No.: 11/743,720

(22) Filed: May 3, 2007

(51) Int. Cl. G06F 13/14

(52) U.S. Cl. 710/305

(57) ABSTRACT

Flow of commands from logic under test, such as an FPGA, to a receiving component, such as a component in a PCIe hierarchy, is managed. A rate at which flow control signals are received by the logic under test from the receiving component is determined, the flow control signals indicating that there is space available in a buffer in the receiving component for receiving commands. The determined rate of receipt of the flow control signals is used for managing flow of commands from the logic under test to the receiving component without waiting for actual processing of flow control signals by the logic under test.

### BACKGROUND

The present invention relates generally to data processing, and more particularly, to managing flow control.

Field Programmable Gate Arrays (FPGAs) have emerged as alternatives to programmable logic devices and Application Specific Integrated Circuit (ASIC) chips. FPGAs offer the benefit of being readily programmable. Thus, FPGAs are ideal for testing designs at high speed. The designs, may, in turn, be programmed into ASICs.

Many FPGA based Peripheral Component Interconnect (PCI) express designs have been created. PCI express (PCIe) is an emerging protocol for I/O devices that is being rapidly adopted for specifying computer buses for attaching peripheral devices to a computer motherboard. PCI express is a computer system bus/expansion card interface format. While those skilled in the art will be familiar with various aspects of PCIe topologies, details of PCIe are given, e.g., PCI Express Technology White Paper, February, 2004, available at http://www.dell.com/contemt/topics/global.aspx/vector/en/2004_pciexpress?c=us&1=en&s=corp.

PCIe topologies utilizing FPGAs have been primarily used for two things: express verification and prototypes. One of the major uses of express verification is performance verification, and one of the main uses of prototypes is making sure design requirements are correct. A problem arises in using FPGAs in PCIe topologies for verification and design prototyping because FPGAs process data slowly. When an ASIC or an FPGA under test is connected in a PCIe topology, the component under test and the component with which it communicates each need to know how many credits it can use, i.e., how many transactions it can have before it needs to respond. The credits are transmitted during flow control in flow control packets. Flow control is a technique for ensuring that a transmitting component does not overwhelm a receiving component with data. When the buffers in the receiving component are full, the receiving device stops sending credits to the transmitting device. When the sending device is out of credits, it suspends the transmission of new commands. Once the data in the buffers of the receiving device has been processed and new flow control signals are received and processed, the sending device can send new commands. This technique, by which the receiver controls the rate of transmission of the sender to prevent overrun, may be referred to as “pacing”. The flow control signal is sent back from the receiver to the sender indicating how many more commands can be accepted. It takes a long time for an FPGA to process a flow control packet, so there is a delay in the FPGA sending a signal back to the receiving component indicating how many more commands it can accept without encountering an overflow.

In a PCIe topology including FPGAs and ASICs, both the FPGA and the ASIC need to meet the PCIe lane speed, but the FPGAs process data significantly slower. This creates a fundamental problem, since a slow FPGA will indicate that the buffering needs are greater than perhaps they really are. Thus, when an FPGA chip is connected to an ASIC chip, performance problems occur unless the ASIC chip has an oversized buffer to account for the slower processing of data by the FPGA. The problem is an FPGA can't respond to flow control updates fast enough, so it ends up stalling the link when it doesn't need to. This results in making performance testing hard to do. Also, prototypes cannot provide an accurate look at the buffers or at the performance parameters the real chip will require to meet its goals.

The only current solutions are to ignore the flow control or pace the data at a fixed rate, both of which are used in PCIe validation chips. However, ignoring the flow control does not work unless the chip can indefinitely hold the link speed. Pacing the data takes a while and is very specific to certain environmental conditions.

Thus, there exists a need for a technique for managing flow control in a faster way.

### SUMMARY

According exemplary embodiments, a method and system are provided for managing flow of commands from logic under test, such as an FPGA, to a receiving component, such as a component in a PCIe hierarchy. A rate at which flow control signals are received by the logic under test from the receiving component is determined, the flow control signals indicating that there is space available in a buffer in the receiving component for receiving commands. The determined rate of receipt of the flow control signals is used for managing flow of commands from the logic under test to the receiving component without waiting for actual processing of flow control signals the logic under test.

### BRIEF DESCRIPTION OF THE DRAWINGS

Referring to the exemplary drawings, wherein like elements are numbered alike in the several Figures:

FIG. 1 illustrates a PCIe hierarchy in which fast flow control may be implemented according to an exemplary embodiment.

FIG. 2 illustrates in detail a connection between a receiving component and a transmitting component according to an exemplary embodiment.

FIG. 3 illustrates a method for fast flow control according to an exemplary embodiment.

### DETAILED DESCRIPTION

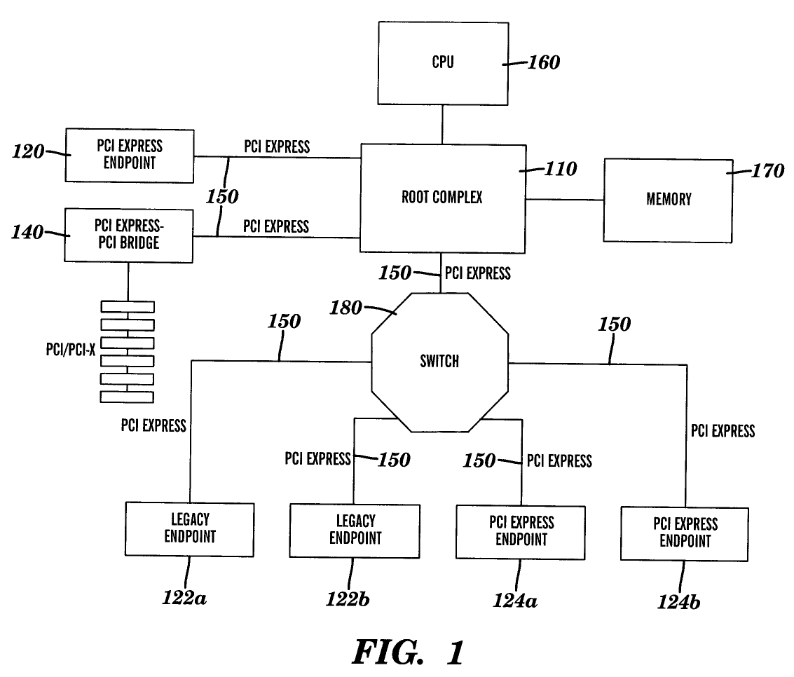

FIG. 1 illustrates an example of a PCIe hierarchy in which fast flow control may be implemented according to an exemplary embodiment. The PCIe topology includes point-to-point links that interconnect a set of components. FIG. 1 shows a single fabric instance, referred to as a PCIe hierarchy. The PCIe hierarchy includes a root complex 110, multiple endpoints (I/O devices) 120, 122a, 122b, 124a, and 124b, a switch 130, and a PCI Express-PCI Bridge 140, all interconnected via PCI Express Links 150. The hierarchy also includes memory a CPU 160 and a memory 170.

The root complex 110 is the root of an I/O hierarchy that connects the CPU 160 and a memory 170 to the I/O devices 120, 122a, 122b, 124a, and 124b. The root complex 110 may support one or more or PCI express ports. Each interface defines a separate hierarchy domain. Each hierarchy domain may include a single endpoint or a sub-hierarchy including one or more switch components and endpoints.

The endpoints 120, 122a, 122b, 124a, and 124b are transmitters (requesters) or receivers (completers) of a PCIe transaction. Each endpoint acts either on its own behalf or on behalf of a distinct, non-PCI express device, e.g., a PCI express attached graphics controller, or a PCI express-USB host controller. Further details of a PCIe hierarchy may be found, e.g., in the afore-mentioned PCI Express Technology White Paper.

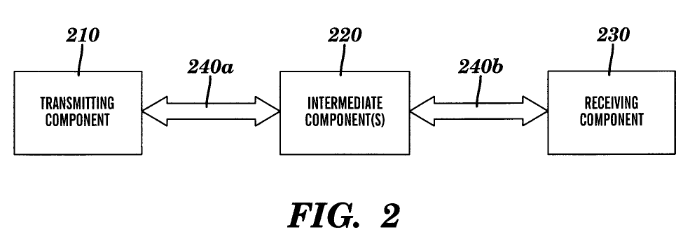

The PCIe hierarchy of interconnected components may be thought of as including a transaction layer, an intermediate layer, and a physical layer. The transaction layer operates at the level of transactions, e.g., read, write, etc. The physical layer directly interacts with the communication medium between two components. The data link layer is the intermediate layer between the transaction layer and the physical layer. A packet generated in the transaction layer to convey a request or indicate a completion may be referred to as a transaction layer packet (TLP). Flow control is handled by the transaction layer in cooperation with the data link layer. The transaction layer tracks flow control credits for TLPs across a link. Transaction credit status may be periodically transmitted to remote transaction transport services of the data link layer, and remote flow control information may used to throttle TLP transmission. The flow control signal may be a data link layer packet (DLLP) used to send flow control information from the transaction layer in one component to the transaction layer in another component. The flow control signal indicates buffer status of a component. A flow control signal sent from a receiving component to a transmitting component communicates buffer status of the receiving component to the transmitting component to prevent buffer overflow in the receiving component and allow the transmitting component to comply with ordering rules. Flow control is used to track the queue/buffer space available in the receiving component across a link, such as that shown in FIG. 2. That is, according to exemplary embodiments, flow control is point-to-point, across a link.

Referring to FIG. 2, flow control information is transferred between a transmitting component 210 and a receiving component 230 via an intermediate component 220 over links 240a and 240b. While only one transmitting component, one receiving component, and one intermediate component are shown for ease of illustration, it should be appreciated that there may be any number of such components, and, in turn, there may be any number of interconnecting links.

According to an exemplary embodiment, logic under test, e.g., an FPGA under test, may be inserted in a PCIe hierarchy as an endpoint. The FPGA may be considered as the transmitting component 210, and the receiving component 230 may be another endpoint, such as any of the endpoints shown in FIG. 1. The intermediate component 220 may include one or more of the switch 180, the root complex 110 and the bridge 140. The links 240a and 240b may be PCI links.

According to an exemplary embodiment, the flow control information is transferred between the receiving component 210 and the transmitting component 230 using flow control packets. The flow control packets include “credits” indicating the amount of buffer space available in the receiving component. These “credits” of buffer space are consumed by different components, depending on the type of transaction. For example, a memory write request might consume one type/amount of credits, while a memory read request might consume a different type/amount of credits.

According an exemplary embodiment, for each type of information tracked by a transmitting component, such as a FPGA under test, there are two quantities tracked for flow control: credits consumed and credit limit. The credit consumed is the count of the total number of flow control units consumed by the transmitting component transmissions since flow control initialization. The credit limit is the number of flow control units legally advertised by the receiver. This represents the total number of flow control credits made available to the receiver since flow control initiation.

The receiving component also tracks flow control. In a receiving component, for each type of information tracked, there are two quantities tracked: credits allocated and credits received. The credits allocated, in this case, are the count of the total number of credits granted to the transmitter since flow control initialization. The credits received may be optionally tracked for error checking. The credits received are the count of the total number of flow control units consumed by valid TLPs since flow control initiation.

For purposes of this discussion, the focus is on flow control at the transmitting component. As an example, a FPGA might send command A for performing a transaction, and a receiving component in the PCIe hierarchy might return credits via a flow control signal, indicating that it has space available for receiving additional commands. It takes the FPGA a while to process the flow control signal from the receiving component to see that there are credits available so that it can send additional commands to the receiving component. According to an exemplary embodiment, rather than waiting for the FPGA to process the flow control signal from the receiving component before the FPGA sends out additional commands, an assumption is made that the flow control signal will be received from the receiving component within a certain amount of time indicating credits are available, and commands B and C may be sent from the FPGA for performing transactions in the receiving component.

According to an exemplary embodiment, an FPGA can anticipate that it will receive flow control packets from a receiving component in a cycle x, where x may be determined by tracking the time it takes for the flow control packets to get returned to the FPGA from the receiving component historically. This may be referred to as “fast flow control”. The cycle/rate “x” may be determined by recording rates of receipt of flow control packets by the transmitting component over time and using the maximum delay recorded within an acceptable delay range/window as the rate of receipt. Of course, there may be other alternatives for determining the rate of receipt of the flow control packet, such as using an average recorded delay as the rate of receipt. However, using the maximum recorded delay recorded within an acceptable delay range window may provide more accurate flow control and decrease the likelihood of buffer overrun at the receiving component.

According to an exemplary embodiment, the transmission of commands from the FPGA to the receiving component is controlled based on the determined rate or cycle of receipt of flow control signals by the FPGA rather than waiting on the FPGA to actually receive and process the flow control packet. This may create the potential for a link buffering error if the flow control rate changes abruptly. However, the risk is much smaller than conventional solutions and gives much greater flexibility for link performance and system concept validation. Also, most chips, once they reach a steady state, return flow control very predictably.

If, for some reason, the flow control signal is never received by the FPGA for processing within an acceptable time window (explained in more detail below), “fast flow control” may be interrupted, and an error signal may be generated. If an error is generated, depending on the environment, it may not be recoverable. If a buffer in the receiving component is not overrun, the error should be recoverable. In this case, the FPGA may simply just switch out of the “fast flow control” mode and stop sending commands until flow control packets are actually processed. If the buffer in the receiving component is overrun, an overflow error may be generated by the receiving component and detected by the root complex 110. In this case, the root complex 110 may send an interrupt message to the CPU 160 to stop processing until the error is corrected. Also, in this case, the FPGA would have stopped using “fast flow control” since the flow control signal would not have been received for processing by the FGPA within the acceptable time window.

As an illustrative example, assume the flow control packet arrives at the FPGA at a rate of y, and the FPGA takes 700 ms to process the flow control packet. According to conventional flow control techniques, the FGPA would be able to send commands at time ˜y+700 ms. In contrast, an ASIC would usually be able to process flow controls signals faster and send commands in, e.g., ˜y+200 ms. So, realistically, the FPGA could use that flow 700 ms earlier to send the next command. If the FPGA were to wait the additional 500 ms to process the flow control packet before sending out a command, this would either reduce performance or drive a chip to increase its buffering to account for the extra delay. While 700 ms is used here as an example of the time it may take an FPGA to process a flow control signal, it should be appreciated that the delay in processing by an FPGA may be longer or shorter, depending on the design. According to an exemplary embodiment, rather than waiting 700 ms to process the flow control packet before transmitting commands, the FPGA may automatically send commands at a rate of y.

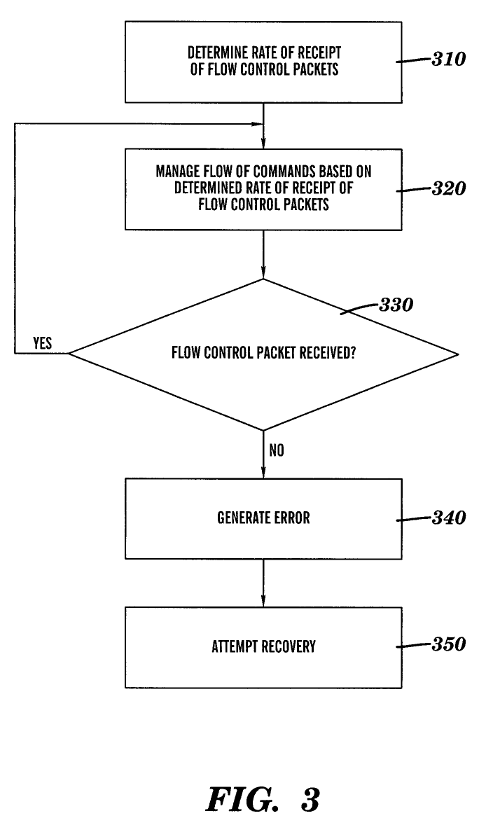

FIG. 3 illustrates an exemplary method for fast flow control according to an exemplary embodiment. The method begins at step 310 at which the rate or frequency at which a flow control packet is historically received by logic under test, e.g., an FPGA, is determined. This flow control packet indicates that there is buffer space available at the receiver for receiving commands for performing transactions. At step 320, the determined flow control rate is used to control flow of commands from the transmitter component to the receiver component rather than waiting for actual receipt and processing of a flow control packet by the transmitting component. At step 330, a determination may be made whether a flow control packet is actually received by the transmitting component. If so, the process may continue from step 310 with the flow of commands continuing to be managed based on the determined rate of receipt of flow control packets. As an alternative, the process may return to step 310, and the rate of receipt of flow control packets may be updated, if applicable, based on the delay taken between receipt of the last flow control packet and receipt of the flow control packet before that. As yet another alternative, the rate of receipt of flow control packets may be updated randomly or at periodic intervals.

If, at step 330, it is determined that no flow control packet was received from the receiving component, an error signal may be generated at step 340, and recovery may be attempted at step 350. These steps may be combined as one, with recovery attempted immediately upon generation of an error signal. As an alternative, the step of recovery 350 may be performed without explicit generation of an error signal. The recovery may include a corrective action, such as halting automatic transmission of commands by the transmitting component based on a determined rate of receipt of flow control packets and waiting, instead, upon actual receipt and processing of a flow control packet by the transmitting component before permitting the transmitting component to transmit commands to the receiving component. This corrective action may be suitable, as long as the buffer of the receiving component is not overrun. If the buffer is overrun, an explicit overflow error signal may be generated to indicate a fatal error, in which case the system would halt processing until the error were corrected.

The method may be implemented using a setup sequence with the following parameters:

last_packet_delay=flow control delay from the previous packet

delay=delay of current flow control packet from the last_packet_delay

highwater mark=number of packets needed for a stable link

A flow margin can be created, e.g., 50 ns, and this may be referred to as “fmargin”. Assume that if flow control packets are not received within this flow margin, then no commands will be sent out by the transmitting component until a flow control packet is actually received and processed by the transmitting component, as the flow control is too variable. Also, consider “max” and “min” to represent, respectively, the maximum and minimum variation seen in the flow control packet delay, and consider “max_recorded” to be the maximum flow control packet delay recorded and “min_recorded” to be the minimum flow control packet delay recorded. Finally, consider “count” to be the number of flow control packets received and “credit” to be the number of transactions that may be sent to the transmitter. Max/Min represent the largest/smallest amount of variation allowed in the flow control packet delay. Defining these parameters, in effect, creates a window during which the flow control packet is allowed to be received. If a current delay in receipt of the flow control packet is within the defied window, then the flow control widow has been properly defined, and the rate of receipt of flow control packets may be accurately predicted. Otherwise, a new window of delay may need to be created.

Given the parameters defined above, the following sequence represents an example of a set up sequence for implementing a flow control method in one embodiment.

```
if (max >= delay >= min)
    if (count < highwater mark)
      count = count + 1;
    end;
    if delay > max_recorded then
      max_recorded = delay
    else if delay < min_recoreded
      min_recorded = delay
    end
else  //  The  flow  control  is  too  variable,  reset
    count = 0;
    max_recorded = delay
    min_recorded = delay
    max = delay + fmargin;
    min = delay − fmargin;
end
/// Flow control is within the margin
if count = highwater then
    fastflowcontrol = 1;
end
current_delay = the current delay since the last packet
if transactions available then
    if credits = 0 then
      if fastflowcontrol = ‘1’ then
        if current_delay > max_recorded
          send transaction
          (the current flow control will be instantly consumed)
        Else
          wait
        end
      else
        wait
      end
    Else if credits >= 1 then
      send transaction
      consume credit
    end
else
    wait
end;
```

In the example setup sequence given above, the delay parameters are set based on variability of the delay in receipt of flow control packets. Then, conditions are defined for consuming credits based on available credits and delay since the last flow control packet. According to an exemplary embodiment, the setting of delay parameters may be performed by a CPU or a microprocessor in communication with logic under test, such as a FPGA. The CPU or microprocessor may instruct logic under test to carry out the consumption of credits and sending of commands automatically once the rate of receipt of flow control packets is defined. The logic under test may continue sending out commands automatically without first receiving and processing flow control packets, as long as the flow control packets are eventually actually received and processed within an acceptable amount of time.

Considering the example above, with fmargin of 50 ns, assume a delay is found of 100 ns. Thus, the window is from 150 ns (max) to 50 ns (min). Then, assume there is a stream of delays in receiving flow control packets of 100 ns, 75 ns, 110 ns, 130 ns, 80 ns, and 101 ns. The max_recorded parameter would be 130 ns. Then, assume a command is to be sent but there are no credits available, and it has been longer than 130 ns (max_recorded) from the last used credit update. The command may be sent based on the assumption that the flow control packet has been received by the transmitting component but just hasn't been processed yet. To ensure the receiving component buffer is not overrun, the transmitting component may wait until another 130 ns passes before sending another command.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for managing flow of commands from logic under test to a receiving component, the method comprising:
determining a rate at which flow control signals are received by the logic under test from the receiving component over time, the flow control signals indicating that there is space available in a buffer in the receiving component to receive commands for performing transactions; and
using the determined rate of receipt of the flow control signals by the logic under test for managing flow of commands from the logic under test to the receiving component without waiting for actual processing of the flow control signals by the logic under test.

2. The method of claim 1, wherein the logic under test is a field programmable gate array (FPGA).

3. The method of claim 1, wherein the logic under test is connected to the receiving component via a Peripheral Component Interconnect Express (PCIe) link.

4. The method of claim 1, further comprising determining whether a flow control signal is actually received by the logic under test.

5. The method of claim 4, wherein if the flow control signal is not actually received by the logic, the method further comprises generating an error signal.

6. The method of claim 4, wherein if the flow control signal is not actually received by the logic, the method further comprises attempting recovery.

7. The method of claim 6, when attempting recovery comprises interrupting use of the determined rate of receipt of the flow control signals for controlling transmission of commands from the logic under test and waiting until actual processing of a flow control signal from the receiving component indicating buffer space is available in the receiving component for performing transactions before sending a command from the logic under test to the receiving component.

8. The method of claim 1, wherein the rate of receipt of flow control signals is determined based on a maximum delay recorded for receipt of a flow control signal within a window of acceptable delay.

9. The method of claim 4, wherein the step of determining whether a flow control signal is actually received by the logic under test includes determining whether the flow control signal is received within a window of acceptable delay.

10. The method of claim 9, wherein if the flow control signal is not received within a window of acceptable delay, the use of determined rate of receipt of the flow control signals for controlling transmission of commands from the logic under test is interrupted.

11. A system for managing flow of commands from logic under test to a receiving component, the system comprising:
logic under test; and
a receiving component receiving commands from the logic under test, wherein the receiving component transmits flow control signals to the logic under test indicating that there is space available in a buffer in the receiving component for receiving commands, and the logic under test manages flow of commands to the receiving component based on a determined rate of receipt of the flow control signals without waiting for actual processing of the flow control signals from the receiving component.

12. The system of claim 11, wherein the logic under test is a field programmable gate array (FPGA).

13. The system of claim 11, wherein the logic under test is connected to the endpoint via a Peripheral Component Interconnect Express (PCIe) link.

14. The system of claim 11, wherein the logic under test determines whether a flow control signal is actually received by the logic under test.

15. The system of claim 14, wherein if the flow control signal is not actually received by the logic under test, an error signal is generated.

16. The system of claim 14, wherein if the flow control signal is not actually received by the logic under test, recovery is attempted.

17. The system of claim 16, wherein recovery is attempted by interrupting use of the determined rate of receipt of the flow control signals for controlling transmission of commands from the logic under test and waiting until actual processing of a flow control signal from the receiving component before sending a command from the logic under test to the receiving component.

18. The system of claim 11, wherein the rate of receipt of flow control signals is determined based on a maximum delay recorded for receipt of a flow control signal within a window of acceptable delay.

19. The system of claim 14, wherein the logic under test determines whether the flow control signal is received within a window of acceptable delay.

20. The system of claim 19, wherein if the flow control signal is not received within a window of acceptable delay, the use of determined rate of receipt of the flow control signals for controlling transmission of commands from the logic under test is interrupted.
